(19) United States
(12) Patent Application Publication
(10) Pub. No.: US 2023/0294206 A1
(43) Pub. Date: Sep. 21, 2023

(54) LASER WELDING METHOD FOR JOINING A NON-SINTERED MATERIAL TO A SINTERED MATERIAL, COMPOSITE BODY, AND USE OF A LASER WELDING METHOD

(71) Applicant: ECO HOLDING 1 GMBH, Marktheidenfeld (DE)

(72) Inventor: Arne Friedrich, Marktheidenfeld (DE)

(73) Assignee: ECO HOLDING 1 GMBH, Marktheidenfeld (DE)

(21) Appl. No.: 18/017,055

(22) PCT Filed: Jul. 14, 2021
(86) PCT No.: PCT/EP2021/069611

§ 371 Date: Jan. 19, 2023

(30) Foreign Application Priority Data
Jul. 21, 2020 (DE) 102020119091.3

(51) Int. Cl. B23K 26/32; B23K 26/244; B23K 26/323

(52) U.S. Cl. CPC B23K 26/32; B23K 26/244; B23K 26/323

(57) ABSTRACT

A laser welding method for joining a non-sintered material to a sintered material is disclosed. The method includes the steps of providing a first component made of a non-sintered material, providing a second component made of a sintered material, arranging the first component and the second component along a contact plane to produce a joining joint, applying a laser beam to a first joining region of the first component in the region of the joining joint to melt the first joining region to a melt, melting a second joining region of the second component in the region of the joining joint by means of the melt of the first joining region, and cooling the joining joint.

### CROSS REFERENCE TO RELATED APPLICATIONS

This application is a national phase of international application PCT/ EP2021/069611, filed on Jul. 14, 2021, which claims the benefit of priority to German patent application 102020119091.3, filed on Jul. 21, 2020, the content of both of which is herein incorporated by reference.

### BACKGROUND OF THE INVENTION

### Field of the Invention

The present disclosure relates to a laser welding method for joining a non-sintered material with a sintered material. The present disclosure also relates to a composite body comprising a first component made of a non-sintered material and a second component made of a sintered material. The present disclosure further relates to the use of a laser welding method for joining a non-sintered material to a sintered material.

### Description of Related Art

Laser welding methods are mainly used for welding components that have to be joined at high welding speeds, with a narrow and slim weld seam form and with low thermal distortion. This process, also known as laser beam welding, is usually carried out without a supplementary material. A major advantage of laser-welded components is the less concen-trated energy input into the workpiece compared to other welding processes.

However, joining carbon-containing components by means of a laser welding method is problematic. So far, sintered materials, especially those with an increased carbon content, cannot be welded to a non-sintered material by means of laser beam welding. The application or coupling of a laser beam into the sintered material leads to unavoidable impurities due to the material properties, i.e., porosity and carbon content, and to structural changes and even local destruction of the structure due to the energy density of the laser beam. In addition, the carbon index of sintered materials containing carbon often exceeds the permissible limit or reference value for a stable hardness curve within the welded joint to avoid cracks.

Nevertheless, the known state of the art at least mentions that non-sintered materials and sintered materials can be joined by means of the laser welding method, without describing this in detail. However, a concrete solution to the problems mentioned for coupling a laser beam into a sintered steel component is not known. As an example, the publications DE 10 2004 038 681 A1, DE 10 2016 220 830 A1 and DE 10 2017 119 264 B4 may be mentioned.

### BRIEF SUMMARY OF THE INVENTION

It is therefore an object of the invention to provide a laser welding method as mentioned above for joining a non-sintered material to a sintered material, as well as a composite body resulting from this method and the use of a laser welding method for joining a non-sintered material to a sintered material.

According to one aspect, the object is solved by a laser welding method for joining a non-sintered material to a sintered material, comprising the following steps: providing a first component made of a non-sintering material, providing a second component made of a sintering material, arranging the first component and the second component along a contact plane to produce a joining joint, applying a laser beam to a first joining region of the first component in the region of the joining joint to melt the first joining region to a melt, melting a second joining region of the second component in the region of the joining joint by means of the melt of the first joining region, and cooling the joining joint.

The sintered material in the second joining region is thus melted by the melt of the non-sintered material from the first joining region. The laser beam is directly applied to or coupled into an edge area of the non-sintered material. This is why the term indirect laser welding is used in this context. The laser welding method according to the invention brings with it the advantage that a stable welded joint suitable for large-scale production is easily produced between a non-sintered material and a sintered material. In particular, welding instead of screwing is now possible for many areas of use. This leads to a considerable reduction in material and manufacturing costs. In addition, the laser welding method can be used very flexibly for different geometries of the components to be joined, which in turn significantly reduces the process and/or manufacturing costs.

Sintered metals often have so-called barrier layers, such as martensite structures. Martensite is a metastable structure that is formed without diffusion and thermally by a cooperative shear movement from an initial structure, in this case the sintered material, and leads to a particularly high strength or hardness. A barrier layer thus has a fundamentally positive effect on the material properties of a sintered metal or the second component but makes joining or bonding with the non-sintered material or the first component more difficult. Removing the barrier layer facilitates and accelerates the joining of the non-sintered material and the sintered material.

For a better understanding, the terms contact plane, joining joint and joining region should be explained in more detail at this point. The contact plane is a virtual surface against which the two components to be joined are placed in order to be welded together. Thus, during a welding process, the first component is arranged on one side and the second component on the other or opposite side of the contact plane. Thereby, the two components are in contact with each other at least in a section. As already mentioned, the two components thereby form or create a joining joint. The joining joint is understood to be a joint edge which runs along outer edge sections of the two components where the components are in contact with each other. Here, an outer edge section of one component can either rest on an outer surface of the other component that extends beyond its outer edge or be flush with an outer edge section of the other component. Two joining regions extend along the joining joint, more precisely the first joining region of the first component and the second joining region of the second component. The joining region is the part or section of a component that is directly involved in the welding process. In the case of the first component made of the non-sintered material, it is the part which is converted to a melt when the laser beam is applied. In the case of the second component made of the sintered material, it is the part which is melted by means of the melt of the first joining region, whereby the two joining regions are fused or joined together.

In an advantageous embodiment, the laser beam is aligned parallel to the contact plane during the application. Preferably, the laser beam is also directed frontally or on the front side onto the first joining region of the first component. This allows the laser beam to achieve its maximum effect and a high penetration depth. With this alignment of the laser beam, a maximum penetration depth and an increased strength of the weld seam can be achieved. Such an alignment of the laser beam is particularly suitable in the case of a joining joint where the outer edge sections of the two components are flush with each other. The risk of unintentionally applying the laser beam to the second component made of sintered material is thus reduced.

According to a preferred embodiment, the laser beam is aligned at an angle α to the contact plane during the application, whereby the angle α is a maximum of 45°, in particular a maximum of 30°, in particular a maximum of 15°. The greater the penetration depth in the joining joint, the greater the strength of the welded joint. A deviation of the angle α from 0° can be provided if, for example, the first joining region cannot be reached with a laser beam aligned parallel to the contact plane due to structural conditions or if no parallel weld root is formed and thus the penetration depth would be reduced. Up to a maximum angle of 45°, however, the laser beam can still have sufficient effect to melt the joining region of the first component. Such an angled alignment of the laser beam is particularly suitable when the outer edge section of one component to be joined rests on an outer surface of the other component that extends beyond its outer edge. This either minimises the danger of applying the laser beam to the second component or makes it possible at all to apply the laser beam to the first joining region.

In another advantageous embodiment, the laser beam is applied by means of a continuous or pulsed laser beam. Thereby, it depends, for example, on the geometry, but also on the thermal conductivity of the non-sintered material, whether a continuous or a pulsed welding process is advantageous.

Continuous laser welding is an uninterrupted welding process and is particularly suitable for welding thick components, as well as refractory metals such as titanium, chromium and tungsten.

During pulsed laser welding, the energy supply is emitted at time-limited intervals. After each laser pulse, there is a short pause in which the previously generated melt can cool down. This process, also known as fine welding, is particularly suitable for thin-walled workpieces, such as light and thin metals, for joining components of very different geometries, and for materials that are difficult to weld. It prevents the components from deforming or melting more than desired.

According to the invention, the application is advantageously carried out by means of laser beam MSG hybrid welding. The laser beam-MSG hybrid process or laser beam-MSG hybrid welding is the combination of a laser beam with an MSG welding process in a common process zone (MSG = metal shielding gas welding). Thereby, the advantages of both processes are used. Very deep penetration with good flank bonding is achieved. A very narrow heat-affected zone with little distortion is created. The process allows very high welding speeds, which leads to a lower energy input per unit length. The main reason for high efficiency is reduced weld preparation. Entire work steps can be omitted.

In a preferred embodiment, the first component is provided by means of a component made of steel and the second component is provided by means of a component made of a carbonaceous sintered steel. The providing of such a combination is particularly suitable for the production of a camshaft adjuster, which is usually configured as a hydraulic phase adjuster or as a swivel motor. Specifically, this embodiment is suitable for welding an end cover made of steel to a stator made of a carbon-containing sintered steel. Conversely, the laser welding method brings significant savings in material and thus in costs when manufacturing the camshaft adjuster, in particular compared to previously used screw connections.

According to a further preferred embodiment, the first component is provided by means of a circular disc-shaped component and the laser beam is applied from radially outside to the first joining region and guided on a circular path parallel to the contact plane around at least one of the components. Alternatively or in combination, it is also possible to install a laser device providing the laser beam in a fixed position and to rotate the components in such a way that the relative movement between the laser beam and the components is the same as when the laser beam or the laser device is guided on the circular path around the at least one component. This variation of the process steps is also particularly suitable for welding an end cover to a stator when manufacturing a camshaft adjuster.

According to a further aspect, the object is solved by a composite body comprising a first component made of a non-sintered material and a second component made of a sintered material. In this case, the composite body is produced according to a method according to the preceding embodiments. The composite body has similar advantages as the method according to the invention.

The sintering material of the second joining region is thus melted by the melt of the non-sintering material of the first joining region. The laser beam is directly applied to or coupled into an edge area of the non-sintered material. Consequently, even difficult to join material pairs, which comprise different properties or can be used for different purposes, can be welded together.

Preferably, the first component is circular disc shaped. Thus, for example, the first component has the shape of the end cover on the stator of a camshaft adjuster. A circular design of the first component enables or facilitates a uniform application of the laser beam from radially outside onto the first joining region while the laser device is guided on a circular path around the first component.

Furthermore, the first component is preferably designed as a cover, in particular as a stator cover on a camshaft adjuster. The stator cover corresponds to the end cover for the stator on the camshaft adjuster. The second component is preferably designed as a stator, in particular as a stator of a camshaft adjuster.

In connection with these two embodiments, the particular suitability of the laser welding method for manufacturing a camshaft adjuster should be emphasised once again. The stator of the camshaft adjuster is designed, for example, with teeth for a chain drive. In order to ensure a hardness necessary for carrying a chain, the stator is preferably made of a hardenable sintered material. A laser welded joint between this sintered material and a stator cover made of a non-sintered material is possible in a particularly good form by means of the laser welding method according to the invention. The stator cover, on the other hand, can be made of an easily weldable steel. For example, this is a stamped steel sheet with a thickness of less than 6 mm or preferably less than 3 mm.

In an advantageous embodiment, the sintered material is a sintered metal, preferably a sintered steel. Sintered metal is ideally suited for components that require several machining processes, comprise complex geometries and/or integrate several subcomponents in a new component, as it is the case with the stator, for example.

In a particularly preferred embodiment, the sintered metal comprises a carbon content of preferably between 0.3 and 0.9 percent, in particular between 0.5 and 0.8 percent, in particular 0.6 percent. With increasing carbon content, steel and in particular sintered steel can be hardened better. At the same time, a material with the lowest possible carbon content is most suitable for the laser welding method in order to reduce material residual stresses. A corresponding optimum exists at 0.6 percent carbon content in order to provide a sufficiently hardenable material, but which can also be used for the laser welding method according to the invention.

Furthermore, the non-sintering material is preferably a metal, preferably a steel. Such a non-sintered material is stable and particularly well machinable and/or joinable by laser welding.

According to the invention, the non-sintered material also advantageously has the lowest possible carbon content, in particular a carbon content of no more than 0.2 percent, and thus, a reduced material residual stress. For example, the steel has a carbon content of about 0.02 percent and a manganese content of about 0.2 percent. This ensures good weldability.

According to a further aspect, the problem is solved by using a laser welding method for joining a non-sintered material to a sintered material. A laser beam is applied to a first joining region of the non-sintered material in the region of a joining joint for melting the first joining region to a melt, and a second joining region of the second component is melted in the region of the joining joint by means of the melt of the first joining region. The use of the laser welding method and the following embodiments for using this method provide similar advantages as the laser welding method according to the invention and/or the composite body according to the invention.

The sintered material in the second joining region is melted by means of the melt of the non-sintered material of the first joining region. For this purpose, the laser beam is directly applied to or coupled into an edge area of the non-sintered material. Therefore, in this context, one speaks of indirect laser welding. The use of the laser welding method according to the invention brings the advantage of easily creating a stable welded joint between a non-sintered material and a sintered material that is suitable for large series production.

In particular, welding instead of bolting is now possible for many fields of application. This leads to a considerable reduction in material and manufacturing costs. In addition, the laser welding method can be used very flexibly for different geometries of the components to be joined, which in turn significantly reduces the process and/or manufacturing costs. The laser beam is applied directly to an edge area of the non-sintered material or coupled into it. The use of the laser welding method according to the invention enables a welded joint between a non-sintered material and a sintered material. Consequently, even difficult to join material pairs, which have different properties or can be used for different purposes, can be welded together.

According to a preferred embodiment, the first component and the second component are arranged along a contact plane to create a joining joint. When using the laser welding method, the laser beam is aligned parallel to the contact plane. This enables the laser beam to achieve its maximum effect and a high penetration depth is achieved. With this alignment of the laser beam, a maximum penetration depth and strength of the weld seam can be obtained. Such an alignment of the laser beam is particularly suitable in the case of a joining joint in which the outer edge sections of the two components are flush with each other. The risk of unintentionally applying the laser beam to the second component made of sintered material is thus reduced.

In an alternative embodiment, when using the laser welding method, a laser beam is aligned at an angle α to the contact plane, wherein the angle α is at most 45°, in particular at most 30°, in particular at most 15°. A deviation of the angle α from 0° can be provided if, for example, the first joining region cannot be reached with a laser beam aligned parallel to the contact plane due to structural conditions or if no parallel weld root is formed and thus the penetration depth would be reduced. Up to a maximum angle of 45°, however, the laser beam can still have sufficient effect to melt the joining region of the first component. Such an angled alignment of the laser beam is particularly suitable when the outer edge section of one component to be joined rests on an outer surface of the other component extending beyond its outer edge.

This either minimises the risk of applying the laser beam to the second component or makes it possible at all to apply the laser beam to the first joining region.

In a further advantageous embodiment, continuous and/or pulsed laser welding is applied when using the laser welding method. Thereby, it depends, for example, on the geometry, but also on the thermal conductivity of the non-sintered material, whether a continuous or a pulsed welding process is advantageous. Continuous laser welding is an uninterrupted welding process that is particularly suitable for welding thick components, as well as for refractory metals such as titanium, chrome and tungsten. In pulsed laser welding, on the other hand, the energy supply is emitted at time-limited intervals. After each laser pulse, there is a short pause in which the previously generated melt can cool down. This prevents the components from deforming or melting more than desired.

According to the invention, a laser beam MSG hybrid welding is used advantageously when using the laser welding method. The laser beam-MSG hybrid process or laser beam-MSG hybrid welding is the combination of a laser beam with an MSG welding process in a common process zone (MSG = metal shielding gas welding). Thereby, the advantages of both processes are used. Very deep penetrations with good flank bonding are achieved. Thereby, a very narrow heat-affected zone with little distortion is created. The process allows very high welding speeds, which leads to lower energy input per unit length. The main reason for high economic efficiency is reduced weld seam preparation. Entire work steps can be omitted.

Further advantages of the invention are apparent from the description and the drawings.

### BRIEF DESCRIPTION OF THE SEVERAL VIEWS OF THE DRAWINGS

Further advantages, features, and details of the various embodiments of this disclosure will become apparent from the ensuring description of a preferred exemplary embodiment and with the aid of the drawings. The features and combinations of features recited below in the description, as well as the features and feature combination shown after that in the drawing description or in the drawings alone, may be used not only in the particular combination received, but also in other combinations on their own, without departing from the scope of the disclosure.

The invention is explained in more detail below with reference to the embodiments shown in the drawings, which depict:

FIG. 1 depicts a cross-section of a first embodiment of a composite body according to the invention before applying a laser beam;

FIG. 2a depicts cross-section of the composite body of FIG. 1 during the application of a laser beam;

FIG. 3a depicts perspective view of a second embodiment of the composite body according to the invention during the application of a laser beam; and

FIG. 4a depicts flow chart of the method according to the invention.

### DETAILED DESCRIPTON OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that at least one of “A, B, and C” should not be understood as including only one of A, only one of B, only one of C, or any combination of A, B, and C.

FIG. 1 shows a cross-section of a first embodiment of a composite body 1 according to the invention before applying a laser beam 11. The composite body 1 is in an early phase of a method according to the invention for its manufacture or of a laser welding method according to the invention for joining a non-sintered material and a sintered material. The first component 2 is made of a non-sintered material and the second component 3 is made of a sintered material. In addition, FIG. 1 shows a laser device 4 which is directed towards the first component 2. The components 2, 3 are located on opposite sides of a contact plane 5 along which they are arranged and thus placed against each other. The first component 2 comprises a first joining region 6. The second component 3 comprises a second joining region 7.

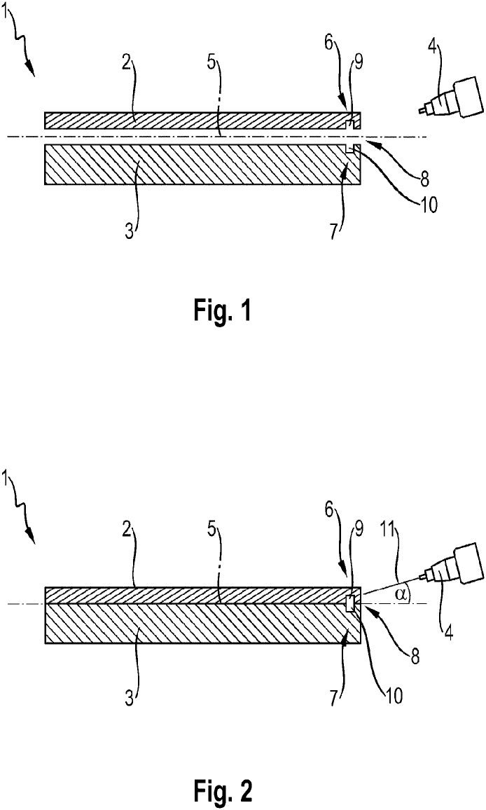

The joining regions 6, 7 are each arranged at the ends of the components 2, 3 facing the laser device 4. The components 2, 3 are arranged along the contact plane 5 and a joining joint 8 is created by means of the joining regions 6, 7. Thereby, the joining joint 8 is arranged along a joint edge. The joint edge extends where the components 2, 3 are flush with each other on the contact plane 5. The joining regions 6, 7 can also each have a groove 9, 10. Specifically, in the example shown, the first joining region 6 has a first groove 9 and the second joining region 7 has a second groove 10. The grooves 9, 10 are arranged opposite to each other and define a common cavity. The functions of the grooves 9, 10 are explained in the following description of FIG. 2.

FIG. 2 shows a cross-section of the composite body 1 of FIG. 1 during the application of a laser beam 11. Compared to FIG. 1, the composite body 1 is shown in an advanced phase of its manufacturing process. As in FIG. 1, the components 2, 3 with their joining regions 6, 7 and grooves 9, 10 can also be seen here. Furthermore, FIG. 2 again shows the laser device 4 and the contact plane 5. However, the components 2, 3 are now located on the contact plane 5 and are thus directly adjacent to each other, generating the joining joint 8. In addition, the laser device 4 is activated in this phase of the process, shown with a laser beam 11 directed towards the first component 2 respectively its joining region 6. Specifically, the process step of applying the laser beam 11 to the first joining region 6 of the first component 2 in the area of the joining joint 8 to melt the first joining region 6 to a melt is shown here. A subsequent respectively resulting process step is the melting of the second joining region 7 of the second component 3 in the area of the joining joint 8 by means of the melt of the first joining region 6. The result is an essentially circumferential welding seam.

The grooves 9, 10 are recessed in the respective component 2, 3 and are arranged on the common contact plane 5 and at least partially parallel to the joining joint 8. Since the two grooves 9, 10 are directly opposite to each other at the contact plane 5, they form a common cavity. The stress on the welding seam can be reduced because during operation of the composite body 1 pressure can be kept away from the welding seam root and dissipated into the surrounding base material.

It is also possible to provide a first respectively a second groove 9, 10 recessed in the first and/or the second component and extending at least partially parallel to the joining joint for gas pressure compensation. This has the advantage, for example, that the melt is less influenced by the diffusion of produced gases, whereby the strength can be additionally increased respectively stabilised. Furthermore, an improved shear strength of the joint can be provided by the flow of the melt into the groove. Furthermore, tensions during the joining process can be significantly reduced, which additionally improves the quality of the welded joint.

Moreover, only one of the grooves 9, 10 can be provided, i.e. either only the first groove 9 or only the second groove 10. Joining the components 2, 3 without any groove is also part of the invention.

When the laser beam 11 is applied to the first joining region 6, the laser beam 11 is aligned at an angle α to the contact plane 5. In this case, the angle α is specifically 15°. Optimally, the laser beam 11 is aligned parallel to the contact plane 5 or with α = 0°, as the laser beam 11 can then develop its maximum effect and penetration effect. However, the angle α can be up to 45° in order to achieve a sufficient effect of the laser beam 11. In principle, three-dimensional stress and heat dissipation states should be avoided.

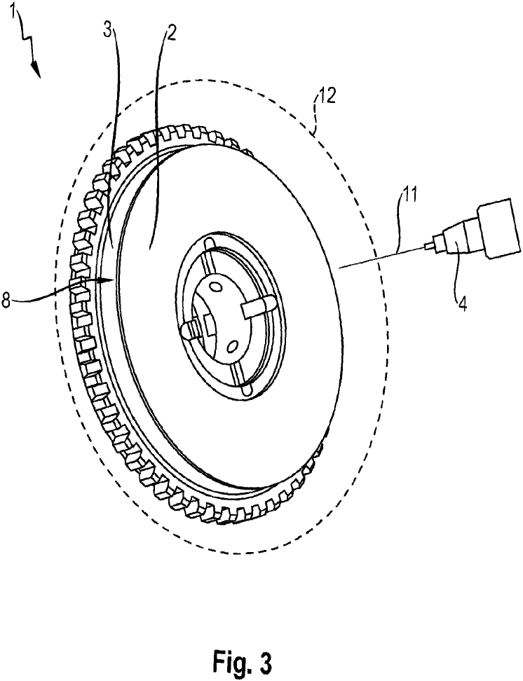

FIG. 3 shows a perspective view of a second embodiment of the composite body 1 according to the invention during the application of a laser beam 11. In this second embodiment, the composite body 1 is shown as part of a camshaft adjuster. The composite body 1 is shown in the advanced phase of its manufacturing process as illustrated in FIG. 2. As in FIG. 2, the first component 2 and the second component 3 can be seen resting against each other along the joining joint 8. The first component 2 is configured as a circular disc-shaped stator cover and is made of a steel with a low carbon content. The second component 3 is formed as a stator of the camshaft adjuster and is made of a sintered steel with a carbon content of 0.6 percent. The selected carbon content of 0.6 percent ensures sufficient hardenability of the sintered steel of the second component 3, but at the same time still allows joining of the components 2, 3 by means of the laser welding method according to the invention.

In addition, FIG. 3 again shows the laser device 4 with the laser beam 11. When applying the laser beam 1, in this embodiment the laser beam 11, and thus also the laser device 4, are guided on a circular path 12 around the first component 2 or the stator cover. Thereby, the laser beam 11 is directed respectively applied to the first component 2 from radially outside. However, the invention is not limited to a circular welding seam. For example, the first component 2 can have a shape that deviates from the circular shape in order to prevent the component 2 from inflating, among other things. For example, the component 2 can be clo-verleaf-shaped so that the circumferential welding seam extends on several radii and extends partially radially. It is also conceivable that several circumferential welding seams are provided which extend separately from each other.

For simplification, the illustration of some details (such as contact plane and joining regions) was omitted in FIG. 3. However, the corresponding explanations for FIGS. 1 and 2 also apply here.

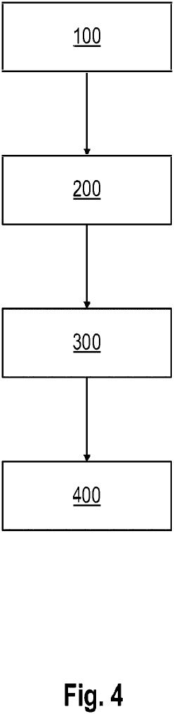

FIG. 4 shows a flow chart of the method according to the invention. The method comprises, after providing a first component 2 made of a non-sintered material and providing a second component 3 made of a sintered material, a first step of arranging 100 the first component 2 and the second component 3 along a contact plane 5 to produce a joining joint 8. In a second step, the method comprises applying 200 a laser beam 11 to a first joining region 6 of the first component 2 in the region of the joining joint 8 in order to melt the first joining region 6 to a melt. In the following process step, melting 300 of a second joining region 7 of the second component 3 takes place in the region of the joining joint 8 by means of the melt of the first joining region 6, and in the last step, cooling 400 of the joining joint 8 takes place.

All features explained and shown in connection with individual embodiments of the invention may be provided in different combinations in the subject matter according to the invention in order to simultaneously realise their advantageous effects.

Since the devices and methods described in detail above are examples of embodiments, they can be modified to a wide extent by the skilled person in the usual manner without departing from the scope of the invention. In particular, the mechanical arrangements and the proportions of the individual elements with respect to each other are merely exemplary. Some preferred embodiments of the apparatus according to the invention have been disclosed above. The invention is not limited to the solutions explained above, but the innovative solutions can be applied in different ways within the limits set out by the claims.

1. A laser welding method for joining a non-sintered material to a sintered material, the method comprising the steps of:
– providing a first component comprising a non-sintered material,
– providing a second component comprising a sintered material,
– arranging the first component and the second component along a contact plane such that a joining joint is produced,
– applying a laser beam to a first joining region of the first component in a region of the joining joint so as to melt the first joining region to a melt,
– melting a second joining region of the second component in the region of the joining joint by means of the melt of the first joining region, and
– cooling the joining joint.

2. The laser welding method according to claim 1, wherein the step of applying a laser beam further comprises the step of aligning the step of applying a laser beam further comprises the step of aligning the laser beam parallel to the contact plane.

3. The laser welding method according to claim 1, wherein the step of applying a laser beam further comprises the step of aligning the laser beam at an angle α to the contact plane, wherein the angle α is at least one of at most 45°, at most 30°, and at most 15°.

4. The laser welding method according to claim 1, wherein the step of applying a laser beam further comprises the steps of applying the laser beam by means of a continuous or a pulsed laser beam.

5. The laser welding method according to claim 1, wherein the step of applying a laser further comprises the step of applying the laser by means of laser beam MSG hybrid welding.

6. The laser method according to claim 1, wherein:
• the step of providing of the first component further comprises the step of providing the first component by means of a first component made of steel, and
• the step of providing the second component further comprises the step of providing the second component by means of a second component made of a carbon-containing sintered steel.

7. The method according to claim 1, wherein:
• the step of providing the first component further comprises the step of providing the first component by means of a circular disc-shaped component, and
• the step of applying the laser beam further comprises the step of applying the laser beam by directing the laser beam from radially outside onto the first joining region and guiding the laser beam on a circular path parallel to the contact plane and around at least one of the components.

8. A composite body, comprising:
• a first component comprising a non-sintered material: and
• a second component comprising a sintered material, and
• wherein the first component and the second component are arranged along a contact plane such that a joining joint is produced.
• wherein the first joining region is melted to a melt.
• wherein a second joining region of the second component in the region of the joining joint is melted by means of the melt of the first joining region, and
• wherein the joining joint are cooled.

9. The composite body according to claim 8, wherein the first component is configured in a shape of a circular disc.

10. The composite body according to claim 8, further comprising at least one groove formed parallel to the joining joint, wherein the groove is formed recessed in one of the first component and the second component.

11. The composite body according to claim 8, wherein the first component is configured as at least one of a cover and stator cover on a camshaft adjuster.

12. Body according to claim 8, wherein the second component is configured as at least one of a stator and a stator of a camshaft adjuster.

13. Body according to claim 8, wherein the sintered material is at least one of a sintered metal and a sintered steel.

14. The composite body according to claim 8, wherein the non-sintered material is at least one of a metal and a steel with a carbon content of at most 0.2%.

15. The composite body according to claim 8, wherein the sintered metal comprises a carbon content between at least one of 0.3 and 0.9 percent, 0.5 and 0.8 percent, and 0.6 percent.

16. (canceled)
